(19) United States
(12) Patent Application Publication
(10) Pub. No.: US 2014/0201709 A1
(43) Pub. Date: Jul. 17, 2014

(54) JavaScript™ Deployment Build Tool for software code that uses an object literal to define meta data and system code.

(71) Applicant: Martin Carl Euerle, Robbinsdale, MN (US)

(72) Inventor: Martin Carl Euerle, Robbinsdale, MN (US)

(21) Appl. No.: 13/741,948

(22) Filed: Jan. 15, 2013

(51) Int. Cl. G06F 9/44

(52) U.S. Cl. CPC G06F 8/31
USPC 717/106

(57) ABSTRACT

This invention is a method to provide deployment support of development software that uses an object literal to define meta data and system code. It supports creating versioned code and merging multiple source files to be downloaded as a single unit.

### BACKGROUND OF INVENTION

This invention is a method to provide support for multiple versions of source code. This method covers support for individual versioned Resource Units that themselves are individual classes, and support for versioned Resource Units that are modules, which themselves contain one or more Resource Units.

### DETAILED DESCRIPTION

The invention can be implemented in numerous ways: as an application, as a process, as a system, or as a computer network where instructions are sent over communication links. The general order of the process may be altered within the scope of the invention. All code samples are for the demonstration of invention concepts. Names of properties can be changed. Exact implementation of version scheme can be changed, etc. The code could be written in a variety of ways.

What the tool does:

### Example 1

### Directory Structure

Development Source Directory:

/project/web/src/

Deployment Full Code Directory:

/project/web/deploy/full

Deployment Minified Code Directory:

/project/web/deploy/min

### Example 2

### Directory Structure with Previous Versions

Development Source Code Directory:

/project/web/src/

os/dir/

Person.js

Deployment Full Code Directory:

/project/web/deploy/full/

module/

Directory_0.9.5.js
Directory_0.9.9js

os/dir/

Person_0.9.0.js
Person_0.9.9.js

Deployment Minified Code Directory:

/project/web/deploy/min/

module/

Directory_0.9.5js
Directory_0.9.9js

os/dir/

Person_0.9.0.js
Person_0.9.9.js

### Example 3

### Resource Type “CLASS” Resource Unit from Development Source Directory

// file: /project/web/src/class/os/dir/Person.js
resourceUnit({

| | |
|---|---|
| name_s | : ”os.dir.Person”, |
| version_s | : ”1.0.0” |
| resourceType_s | : ”CLASS”, |
| activeDevlopment_b | : false, |
| resource_fn | : function(Resource) { |

// Resource Class
var Person = function(firstName_s_p, lastName_s_p) {
}
...
return(Person);

}

});

### Example 4

### Resource Type “MODULE” Resource Unit from Development Source Directory

// file: /project/web/src/module/Directory.js
resourceUnit({

| | |
|---|---|
| name_s | : ”module.Directory”, |
| version_s | : ”1.0.0” |
| resourceType_s | : ”CLASS”, |
| activeDevelopment_b | : false, |
| moduleResourceUnit_ary | : [ |

{ name_s : ”os.dir.Person”,
version_s : ”1.0.0” }

]

});

### Example 5

### Resource Type “MODULE” Resource Unit, an Unminified File Processed from Development Source Directory

resourceUnit({

| | |
|---|---|
| name_s | : ”module.Directory”, |
| version_s | : ”1.0.0” |
| resourceType_s | : ”MODULE”, |
| activeDevelopment_b | : false, |
| moduleResourceUnit_ary | : [ |

{ name_s : ”os.dir.Person”,
version_s : ”1.0.0” }

]

| | |
|---|---|
| resource_fn | : function(Resource) { |

var resourceUnit_ary_m = [ ];
resourceUnit_ary_m.push({

| | |
|---|---|
| name_s | : ”os.dir.Person”, |
| version_s | : ”1.0.0” |
| resourceType_s | : ”CLASS”, |
| activeDevlopment_b | : false, |
| resource_fn | : function(Resource) { |

// Resource Class
var Person = function(firstName_s_p,
lastName_s_p) {
}
...
return(Person);

}

});
return(resourceUnit_ary_m);

}

});

### Build Tool Flow

1.1 Identify the Development Source Code Directory.

1.2 Identify the Deployment Full Code Directory.

1.3 Identify the Deployment Minified Code Directory.

2 For each file:

3.1 If not a valid JavaScript file, identify as an error, go to next file (2).

3.2 If not a valid Resource Unit, identify as an error, go to next file (2).

4 If resourceType_s : “CLASS”
4.1 If activeDevelopment_b : false
   4.1.1 Check for a file in the Deployment Full Code subdirectory that matches the file from the Development Source Code Directory file structure. If a versioned copy exists that matches the fully qualified name and the version of the Development Source Code Directory file Resource Unit, identify as an error, go to next file (2).
   4.1.2 Copy an unaltered version of the Development Source Code Directory file to the identified Deployment Full Code Directory, maintaining the Development Source Code Directory subdirectory structure.
   4.1.3 Check for a file in the Deployment Minified Code Directory subdirectory that matches the file from the Development Source Code Directory file structure. If a versioned copy exists that matches the fully qualified name and the version of the Development Source Code Directory file Resource Unit, identify as an error, go to next file (2).
   4.1.4 Copy a minified version of the Development Source Code Directory file to the identified Deployment Minified Code Directory, maintaining the Development Source Code Directory subdirectory structure.
   4.1.5 The copied file name becomes the original file name with the version.
   4.1.6 Go to the next file (2).
4.2 If activeDevelopment_b : true
   4.2.1 Copy an unaltered version of the Development Source Code Directory file to the identified Deployment Full Code Directory, maintaining the Development Source Code Directory subdirectory structure. Overwrite the file if it matches the fully qualified name and version from the Development Source Code Directory file Resource Unit.
   4.2.2 Copy a minified version of the Development Source Code Directory file to the identified Deployment Minified Code Directory, maintaining the Development Source Code Directory subdirectory structure. Overwrite the file if it matches the fully qualified name and version from the Development Source Code Directory file Resource Unit.

5 If resourceType_s : “MODULE”
5.1 if activeDevelopment_b : false
   5.1.1 Check for a file in the Deployment Full Code subdirectory that matches the file from the Development Source Code Directory file structure. If a versioned copy exists that matches the fully qualified name and the version of the Development Source Code Directory file Resource Unit, identify as an error, go to next file (2).
   5.1.2 Read the module Resource Units from the moduleResourceUnit_ary property, add the Resource Units as identified in Example 5. Copy to the identified Deployment Full Code Directory, maintain the Development Source Code Directory subdirectory structure.
   5.1.3 Read the module Resource Units from the moduleResourceUnit_ary property, add the Resource Units as identified in Example 5. Minify, and copy to the identified Deployment Full Code Directory, maintain the Development Source Code Directory subdirectory structure.
5.2 if activeDevelopment_b : true
   5.2.1 Read the module Resource Units from the moduleResourceUnit_ary property, add the Resource Units as identified in Example 5. Copy, overwrite if needed, to the identified Deployment Full Code Directory, maintain the Development Source Code Directory subdirectory structure.
   5.2.2 Read the module Resource Units from the moduleResourceUnit_ary property, add the Resource Units as identified in Example 5. Minify, copy, overwrite if needed, to the identified Deployment Full Code Directory, maintain the Development Source Code Directory subdirectory structure.
   5.2.3 The copied file name is the original file name with the version information becoming part of the file name.

6 End

The process can add a file monitor to automatically build files as they are updated.

1. A JavaScript™ Deployment Build Tool for software code that uses an object literal to define meta data and system code.

2. A method as recited in claim 1, wherein the software code uses a programming language.

3. A method as recited in claim 2, wherein the programming language is a prototype-based language.

4. A method as recited in claim 2, wherein the programming language is a script language.

5. A method as recited in claim 2, wherein the programming language is JavaScript™.

6. A method as recited in claim 1, wherein an object literal that defines meta data and system code is hereinafter referred to as a “Resource Unit.”

7. A method as recited in claim 6, wherein the Resource Unit contains a set of properties.

8. A method as recited in claim 7, wherein the set of properties contains a property that is a function containing software code, hereinafter referred to as a “Resource Function.”

9. A method as recited in claim 8, wherein the Resource Function contains a class, hereinafter referred to as a “Resource Class.”

10. A method as recited in claim 7, wherein the set of properties contains a property that identifies the fully-qualified name of the Resource Class.

11. A method as recited in claim 7, wherein the set of properties contains a property that identifies the version of the Resource Class.

12. A method as recited in claim 7, wherein the set of properties contains a property that identifies whether the Resource Class code is in an active state of development, as opposed to being a code complete version.

13. A method as recited in claim 7, wherein the set of properties contains a property that identifies the Resource Unit as either a class or a module.

14. A method as recited in claim 7, wherein the set of properties may contain a property that identifies Resource Units contained in a module.

15. A method as recited in claim 13, wherein a module identifies other Resource Units.

16. A method as recited in claim 13, wherein a module that is deployed contains all Resource Unit system code identified for the module.

17. A method as recited in claim 11, wherein all versions of Resource Units are maintained for deployment in both un-minified and minified formats.
